(19) United States
(12) Patent Application Publication
(10) Pub. No.: US 2010/0232080 A1
(43) Pub. Date: Sep. 16, 2010

(54) SEPARATING DEVICE HAVING AN ENERGY STORAGE FOR AN ENERGY-CONDUCTING ELECTRIC LEAD

(75) Inventors: Harald Schermann, Bedminster, NJ (US); Karlheinz Schreyer, Wolfratshausen (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, Munchen (DE)

(21) Appl. No.: 12/738,088

(22) PCT Filed: Aug. 26, 2008
(86) PCT No.: PCT/EP08/61157

§ 371 Date: Apr. 15, 2010

(30) Foreign Application Priority Data
Oct. 17, 2007 (EP) 07118688.6

(51) Int. Cl. H02H 3/20

(52) U.S. Cl. 361/90

(57) ABSTRACT

A separating device for an energy-conducting electric lead includes a monitoring unit for checking the electric properties of a lead section of the lead adjacent to the separating device, an energy storage device that is coupled to the monitoring unit such that the function of the monitoring unit can also be maintained in case of a failure of the lead, and a switching element, which is coupled to the monitoring unit and which is equipped such that in case of a failure of the lead the adjacent lead section can be separated. The disclosure further relates to an energy supply system and to a method for providing electric energy from a control center to a plurality of electric devices via an energy-conducting electric lead having at least one such separating device.

The present invention relates to the technical field of electrical or electronic circuit engineering. In particular, the present invention relates to a separating device for an energy-conducting electric lead which is preferably designed as a closed loop that emerges from a control center and is fed back to the control center in the form of a loop. The present invention further relates to an energy supply system and to a method for providing electrical energy from a control center to a plurality of electrical appliances via an energy-conducting electric lead having at least one separating device of the type described above.

In the context of hazard reporting technology, failures of electrical appliances and/or supply leads or data leads must only ever affect a small and predefined region. In this case, field-dependent considerations determine the maximal size of the ultimately non-functioning part of a hazard reporting system. In this context, the different fields of hazard reporting technology include (a) fire reporting technology (FRT), (b) intrusion or burglary reporting technology (IRT) or (c) voice alarm technology. Voice alarm systems are used for example in hazardous situations to instruct people how to leave a hazard zone as quickly and as safely as possible.

The maximal size of the ultimately non-functioning part can be (a) an individual fire section or a small number of manual fire alarms in a fire reporting system, (b) a safe in a burglary reporting system or (c) merely a loudspeaker in a voice alarm system.

With regard to reporting, the reliability in (a) the FRT or in (b) the IRT can be raised to a high level of reliability in an inexpensive manner using closed annular loops for connecting a plurality of reporting units to a control center. In the case of (c) the voice alarm technology, this is not possible because the control leads which connect a control center to a plurality of loudspeakers are loaded with high energy.

The operational reliability of energy-conducting leads in particular, whose function must be maintained for as long as possible in a hazardous situation (i.e. in the event of fire or destruction), is a serious reliability problem today. The problem of short-circuiting due to a fault or destruction is particularly relevant to the operational reliability in this case.

In order to increase the operational reliability of energy-conducting leads, a range of proposals have been made within interested specialist groups. These include (a) a decentralized energy supply including a powerful battery in the vicinity of important functions, (b) dedicated star-shaped energy supply leads from the control center to the important functions and (c) intrinsically safe installation of the energy supply in special fire-protected pipes featuring lead insulation which bonds in a granular manner under heat (also referred to disparagingly in German as ‘Wasserrohr’, i.e. ‘water pipe’). However, all of these proposals are associated with a high cost, in particular when setting up a voice alarm system.

The object of the invention is to improve the operational reliability of energy-conducting electric leads in a simple manner.

This object is achieved by the subject matter of the independent patent claims. Advantageous embodiments of the present invention are described in the dependent claims.

According to a first aspect of the invention, a separating device for an energy-conducting electric lead is described. The separating device is suitable in particular for an energy-conducting electric lead which emerges from a control center and is fed back to the control center in the form of a loop. The described separating device features (a) a monitoring unit for checking the electric properties of a lead section of the lead, said lead section being adjacent to the separating device, (b) an energy storage device which is coupled to the monitoring unit in such a way that the function of the monitoring unit can be maintained even in the event of a failure of the lead, and (c) a switching element which is coupled to the monitoring unit and is configured such that, in the event of a failure of the lead, the adjacent lead section can be separated.

The invention is based on the insight that it is also possible to guarantee a high degree of supply reliability in the case of a loop-shaped supply lead for electrical appliances, if at least one separating device according to the invention is introduced into the supply lead. By virtue of said separating device, a defective lead section can be separated from the control center even if the separating device according to the invention can no longer be supplied with electrical energy as a consequence of a total destruction of the supply lead. As a result of separating the defective lead section, the function of the electrical appliances that are disposed between the defective lead section and the control center can be maintained.

The electrical appliances can be any peripheral units of a hazard reporting system, e.g. loudspeakers, electromagnets for automatically opening or closing a door, servomotors for butterfly dampers, ventilators or other components of a hazard reporting system for hazard identification and/or hazard resolution.

Provided the loop-shaped supply lead has sufficient separating devices, such that the defective lead section alone can be separated and no intact lead sections need to be separated, all electrical appliances attached to intact lead sections can continue to operate in the event of just one lead defect. In this case, the appliances on one side of the supply lead are supplied via the one branch of the separated loop-shaped lead and the appliances on the other side of the supply lead are supplied via the other branch of the separated loop-shaped supply lead.

A loop-type installation of the supply lead in conjunction with at least one of the separating devices according to the invention offers the advantage that at least partial sections of the supply lead and the attached electrical appliances remain operational. This also applies if a total destruction of the lead occurs at a location in a building. This preserved functionality is highly advantageous in the case of voice alarm systems in particular, as people in danger can be guided quickly and reliably out of the hazard zone.

In this context, the term energy-conducting is understood to mean a transfer of electrical power to the appliance concerned, this being significantly higher in the case of appliances that are used solely to identify or detect a hazardous situation. The power requirement of the individual appliances attached to the electric lead obviously adds up to a total power requirement. The total power requirement for an acoustic warning system comprising e.g. 30 to 100 loudspeakers attached to the shared supply lead is 10 to 1000 Watts. Depending on the number of appliances that are attached, the total power requirement can be even higher for other peripheral units of a hazard reporting system, e.g. servomotors for butterfly dampers, ventilators or electromagnetic door opening or closing mechanisms.

In the context of this application, the term electrical properties is understood to mean electrical characteristic values of the supply lead such as e.g. the supply voltage, a maximum current load before the supply voltage fails and/or a current flowing along the supply lead. The inventive separating device identifies an adjacent lead section as fault-free if at least one of these characteristic values lies within a predetermined tolerance range.

In the case of an acoustic emergency warning system, it is noted that not only the electrical energy required for operation of the loudspeakers (and the amplifiers that might be necessary) can be transferred via the electric supply lead. The voice information for appropriate voice announcements can also be transmitted via the supply lead, such that the supply lead can also be advantageously used for information transfer.

According to an exemplary embodiment of the invention, the energy storage device features a capacitor, and in particular a double-layer capacitor.

In comparison with the use of a rechargeable battery, a capacitor or double-layer capacitor has the advantage that the charging process can take place very quickly and that overcharging is not possible. Moreover, a double-layer capacitor in particular ages considerably more slowly than a conventional accumulator, and therefore a functional check of the energy storage device is not required or at least need only be performed at comparatively long intervals. The double-layer capacitor preferably has a service life of at least 10 years, wherein the capacity decreases by less than e.g. 20% during this period.

In comparison with other capacitors, double-layer capacitors (which are known to interested specialist groups under the terms or brand names Goldcaps, Supercaps, Boostcaps or Ultracaps) have a significantly greater capacity. The high capacity of these capacitors and hence their ability to store electrostatic energy effectively is based on (a) a large electrode surface and (b) the disassociation of ions in a liquid electrolyte, forming a dielectric having a thickness of only a few atom layers.

The use of a double-layer capacitor has the additional advantage that the energy storage device can be integrated in the described separating device in a simple manner. A separate housing for the energy storage device is not required. The separating device can therefore be realized in a compact format.

Following a total interruption of current, a double-layer capacitor having a capacity of approximately 0.5 farad can supply the whole circuit, i.e. the monitoring unit and the switching element in particular, with electrical energy for an extended time period of e.g. 5 seconds. It is therefore possible, even after a total breakdown of the supply lead, to guarantee that the separating element can reliably continue to perform its separating function for the supply lead.

According to a further exemplary embodiment of the invention, the separating device additionally features a rectifier element that is arranged between a node, which can be connected to a terminal of the energy-conducting electric lead, and the energy storage device. The rectifier element can be a conventional diode or an arrangement comprising a plurality of diodes, for example.

The use of a rectifier element has the advantage that the described separating device can be operated using both D.C. voltage and A.C. voltage, and energy storage can be guaranteed in this way. The described separating device can therefore be operated in both D.C. voltage networks and in an A.C. voltage environment, which is present in the case of voice alarm systems, for example. In the case of voice alarm systems, the monitoring tone of an amplifier can be utilized for feeding the energy storage device. This monitoring tone can have a frequency of approximately 10 Hz, for example. However, the energy storage device can also be fed with higher frequencies, such as a frequency which generates an ultrasonic tone, for example.

According to a further exemplary embodiment of the invention, the separating device also has a voltage transformer featuring an input and an output, wherein the input can be connected to a terminal of the energy-conducting electric lead and the output provides an internal supply voltage of the separating device.

The voltage transformer is preferably designed such that a fixed supply voltage of e.g. 5 volts can be provided even if the input is fed with different amplitudes of supply voltage from the lead, e.g. in the range between 9 volts and 150 volts. Furthermore, the input can also be coupled to the above described rectifier element, such that the voltage transformer can also be fed with either a correctly polarized D.C. voltage or an A.C. voltage.

According to a further exemplary embodiment of the invention, the monitoring unit features a processor. In this case, the processor can instruct the described separating device to measure the adjacent lead sections of the loop-shaped supply lead at regular intervals. This measurement can be done independently, without a trigger signal being transmitted by the control center, for example. The measurement results can likewise be evaluated independently by the processor. This can take place during an operating phase without an interfering signal, e.g. background music.

In comparison with a sequential check of the plurality of lead sections of a loop-shaped supply lead being controlled by the control center, the autonomous measurement and evaluation of the relevant adjacent lead sections being undertaken by the individual separating devices has the advantage that the complete lead measurement can be done significantly faster. This is particularly noticeable during the configuration of a hazard reporting system, which lasts considerably longer if the sequential check of the lead sections is controlled by the control center.

According to a further exemplary embodiment of the invention, the monitoring unit comprises a short-circuit identification unit, a voltage detector and/or an overload current identification unit. The lead sections adjacent to the separating device can therefore be examined for all common faults. In addition to short circuits, these include e.g. interruptions or usually creeping interference effects such as electric shunt or corroded connection interfaces. The electrical energy which is required to identify these lead faults can be taken from the energy storage device of the separating device in this case.

According to a further exemplary embodiment of the invention, the separating device additionally comprises (a) a further monitoring unit for checking the electrical properties of a further lead section of the lead, said further lead section being adjacent to the separating device, and (b) a further switching element, which is coupled to the further monitoring unit and is configured such that the further adjacent lead section can be separated in the event of a failure of the lead.

As a result of using two monitoring units and two switching elements, it is possible for two lead sections adjacent to the separating device to be checked independently of each other and to be decoupled from the separating element and hence from the other lead section if necessary. In the context of a loop-shaped supply lead, one lead section is assigned to one branch of the supply lead to the control center in this case, and the other lead section is assigned to the other branch of the supply lead likewise to the control center.

In the same way as the above described monitoring unit, the further monitoring unit can comprise a further short-circuit identification unit, a further voltage detector and/or a further overload current identification unit.

According to a further exemplary embodiment of the invention, both of the switching elements can be controlled in such a way that, after opening both switching elements as a result of an identified lead defect on an adjacent lead section, the further switching element, which is assigned to the further adjacent lead section, can be closed.

After a discrepancy is identified in the electrical properties of a non-functioning lead section, the functioning further lead section can therefore be reconnected by closing the further switching element. The switching element which is assigned to the non-functioning side of the separating device remains open in this case, in order to maintain the separation of the separating device from the defective lead section.

Provision is preferably made for a predetermined delay before the further switching element is closed, thereby making it possible to ensure that other separating elements of the loop-shaped supply lead have likewise completed their checks of the various lead sections.

According to a further exemplary embodiment of the invention, the separating device additionally comprises a live load connection interface for connecting a live load. This has the advantage that the peripheral units of a hazard reporting system can be connected directly to the separating devices. Consequently, the supply lead does not include any further adapters or connection interfaces for the connection of the peripheral units.

The live load connection interface can comprise two connection interface contacts, wherein one connection interface contact is connected to one terminal of the energy-conducting electric supply lead and the other connection interface contact is connected to the other terminal of the energy-conducting electric supply lead. If two switching elements are used, one of the two connection interface contacts can be between both switching elements. In this way, both of the switching elements connected in series can be assigned to one of the two terminals.

According to a further exemplary embodiment of the invention, the separating device additionally comprises a live load monitoring unit for checking the electrical properties of a live load that is connected to the live load connection interface. Using the live load monitoring unit, it is easy to check the correct functioning of the live load or of an electrical appliance. If a failure is identified on the live load side, it is therefore possible to separate the live load from the live load connection interface. Following separation of the live load, the switching element or switching elements can be closed again as necessary. A closed loop-shaped connection lead and all its above-cited advantages can be re-established thus.

The live load can be e.g. a loudspeaker or an amplifier with an attached loudspeaker.

According to a further aspect of the invention, an energy supply system for a plurality of electrical appliances is described. In this case, the electrical appliances are in particular peripheral units of a hazard reporting system. The energy supply system features (a) a control center, (b) an electric lead which emerges from the control center and is fed back to the control center in the form of a loop, and (c) at least one separating device of the type described above. The separating device can be supplied with electrical energy by the control center via the electric lead in this case.

The described energy supply system is based on the insight that, in comparison with a star-shaped cabling installation, in which at least some of the electrical appliances attached to the electric lead are connected directly to the control center, the cabling expense can be significantly reduced by means of a loop-shaped energy supply lead. Using at least one of the above-described separating devices, it is moreover possible to guarantee at least a comparably high level of supply reliability for the individual electrical appliances.

By virtue of the separating device that is provided, a defective lead section can be separated from the control center even if it is no longer possible to supply electrical energy to the inventive separating device following total destruction of the supply lead. As explained above, by means of separating the defective lead section, it is possible to maintain the function of the electrical appliances which are situated between the defective lead section and the control center. It is thus possible to guarantee a high level of supply reliability despite reduced cabling expense.

According to an exemplary embodiment of the invention, the control center comprises (a) a first loop connection interface, to which a lead section of the electric lead emerging from the control center is connected, and (b) a second loop connection interface, to which a lead section of the electric lead returning to the control center is connected.

The two loop connection interfaces can be operated independently of each other, such that the energy supply and in particular the identification and/or the resolution of faults in the electric supply lead can be effected in different ways. It is possible to use the relevant optimal procedure in a flexible manner for the purpose of fault identification and fault resolution in this way.

According to a further exemplary embodiment of the invention, the control center is configured such that the electric lead can be fed via both the first loop connection interface and the second loop connection interface.

In this case, the control center can additionally comprise a measuring entity which, e.g. by measuring the amounts of current that are coupled in via both loop connection interfaces, identifies that one of the separating devices has opened its switching element and therefore has severed the originally closed lead at a location.

According to a further exemplary embodiment of the invention, the control center is configured such that the electric lead can be fed via the first loop connection interface and that a voltage can be detected at the second loop connection interface. This means that during normal operation the loop-type lead is fed via the first loop connection interface only and the second loop connection interface is used to measure the voltage that is returned via the lead. Consequently, if no voltage or a deviating voltage is measured at the second loop connection interface for a specific time, which is required as a maximum for the measurement and if necessary automatic repair of the loop-shaped lead, it is inferred that there is a defect in the supply lead.

According to a further exemplary embodiment of the invention, the control center is additionally configured such that, provided no voltage can be detected at the second loop connection interface for a predetermined time, the electric lead can be fed via both the first loop connection interface and via the second loop connection interface. This has the advantage that the electrical supply of many appliances, which were initially cut off from their electrical supply by the loop separation following an interruption which could not be remedied by the separating device concerned, can be supplied with electrical energy again. Although the interruption in the supply lead is not removed in this way, its effect can be cured in a matter of seconds by virtue of the dual feeding of the supply lead via both loop connection interfaces.

According to a further exemplary embodiment of the invention, the control center is configured in such a way that the feeding of the electric lead can be interrupted for a predetermined time.

The temporary electrical decoupling of the supply lead from a voltage supply which is assigned to the control center can be initiated by an operator e.g. following a repair of a faulty location of the supply lead. For this purpose, the control center can be equipped with a reset function, which can be triggered e.g. by activating a reset button. In the decoupled state, all electrical appliances attached to the supply lead and all separating devices integrated in the supply lead are then without supply voltage.

For example, a time period of two seconds without supply voltage can represent a trigger signal for the separating devices, wherein said trigger signal initiates a check of the lead sections adjacent to the relevant separating device. Following a repair of the supply lead, however, it should be assumed that all lead sections are fault-free. All separating devices will therefore close their switching element or switching elements, thereby re-establishing a closed supply loop.

After the loop-shaped supply lead is closed, it can be fed either via one loop connection interface or alternatively via both loop connection interfaces as set forth above.

According to a further aspect of the invention, a method for providing electrical energy from a control center to a plurality of electric appliances is described. In this case, the provision or transfer of the electrical energy takes place via an energy-conducting electric lead which comprises at least one separating device of the type described above. The described method comprises (a) checking the electrical properties of a lead section of the lead, said lead section being adjacent to the separating device, and (b) separating the lead section which is adjacent to the separating device if a failure of the lead is present.

The described method for providing energy is based on the insight that, particularly in the case of a loop-shaped supply lead, a high level of supply reliability for the attached electrical appliances can be guaranteed if the state of the supply lead is monitored by at least one separating device of the type described above and a section of the supply lead is separated from the control center if necessary. In this case, by virtue of the energy storage device that is used, the separating device can still monitor the electric lead and reliably separate a defective lead section if the separating device does not receive any more electrical energy following a total destruction of at least one lead section. As a result of separating the defective lead section in a suitable manner, it is possible to maintain the function of the electrical appliances which are disposed between the defective lead section and the control center.

Further advantages and features of the present invention are derived from the following exemplary description of currently preferred embodiments. The individual figures of the drawing of this application are to be considered as merely schematic and not true to scale.

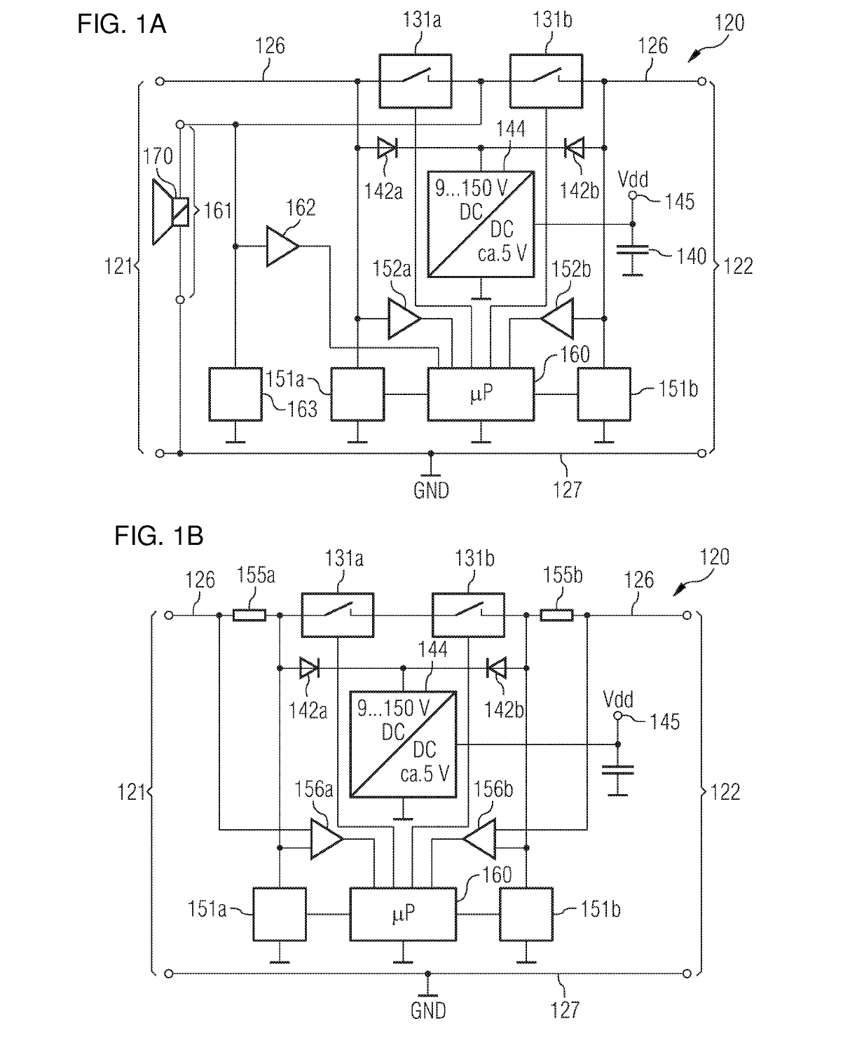

FIG. 1a shows a separating device according to a first embodiment, comprising a voltage detector which is sensitive to a drop in the supply voltage.

FIG. 1b shows a separating device according to a second embodiment, comprising an overload current identification unit.

FIG. 1c shows a separating device according to a third embodiment, comprising just one switching element for separating a supply lead.

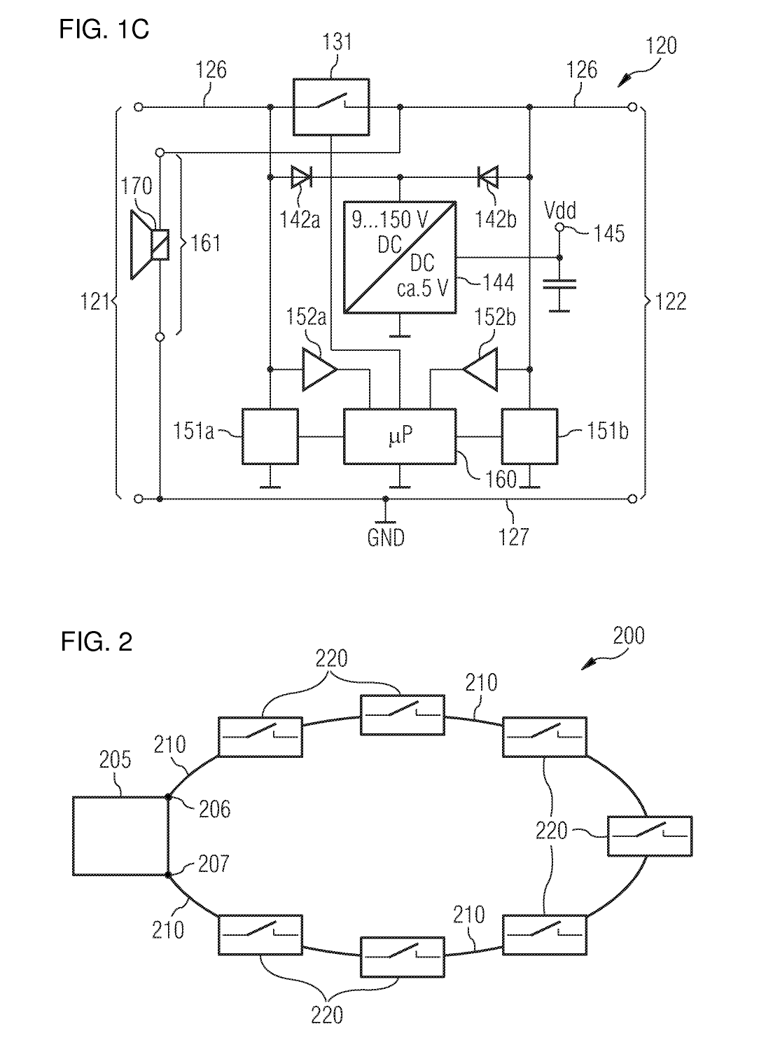

FIG. 2 shows an energy supply system, comprising a control center and a closed loop-shaped supply lead in which a plurality of separating devices are integrated.

It should be noted here that the reference signs relating to identical or corresponding components in the drawing differ only in their first digit and/or by virtue of an added character.

The circuit diagram illustrated in FIG. 1a shows a separating device 120a according to a first embodiment of the invention. The separating device 120a comprises a first connection interface 121 and a second connection interface 122, each of which can be connected to a dual-terminal supply lead. The separating device 120a can be introduced into the supply lead by simply opening the supply lead. In this case, a first conductive track or a first current path 126 is inserted into a first terminal of the supply lead. A second conductive track or a second current path 127 is inserted into the second terminal of the supply lead. According to the exemplary embodiment illustrated here, the second terminal of the supply lead is connected to the O-volt potential, this being designated as GND.

Two switching elements 131a and 131b, which are connected in series and are designed as e.g. transistors or preferably as field-effect transistors, are situated in the second conductive track 126. However, the switching elements 131a, 131b can also be realized in the form of relays (preferably of polarized design) or other semiconductor elements. The switching elements 131a and 131b are coupled via a control lead in each case to a processor which is able to initiate an opening or closing of the switching elements 131a, 131b depending on the operating state of the separating device 120a.

The separating device also comprises an energy storage device 140, which is designed as a double-layer capacitor. One connection interface of the energy storage device 140 is connected to the 0V potential (GND). The other connection interface of the energy storage device 140 is connected to an output of a voltage transformer 144. A supply voltage Vdd for a plurality of components of the separating device 120a is also provided at this output via a connection interface 145. For reasons of clarity, the corresponding wiring is not shown.

The energy storage device 140 allows the separating device 120a to maintain its function, specifically the monitoring function as described below for checking the electrical properties of the supply lead and if necessary the separating function for separating a defective section of the supply lead from the separating device 120a, even if electrical energy can no longer be provided via the supply lead. According to the exemplary embodiment illustrated here, this applies in any case for an extended time period of at least 5 seconds.

The voltage transformer is connected to the first current path 126 via two rectifier elements 142a and 142b which are designed as diodes. As a result of this, the voltage transformer 144 can operate even if the supply lead is fed with an A.C. voltage. According to the exemplary embodiment illustrated here, the voltage transformer 144 accepts a supply voltage in a relatively wide voltage range between 9 volts and 150 volts. The output voltage is approximately 5 volts, and therefore conventional components based on the known transistor-transistor logic (TTL) can be used to realize the separating device.

The separating device 120a additionally comprises two short-circuit identification units 151a and 151b. The short-circuit identification unit 151a can identify a short circuit of the supply lead in a lead section which terminates at the first connection interface. The short-circuit identification unit 151b can identify a short circuit in a lead section which terminates at the second connection interface.

It can be seen from FIG. 1a that the two short-circuit identification units 151a and 151b are coupled to the processor 160 in each case. In the event that a short circuit is identified, the processor 160 can therefore open the switching element 131a or 131b that is oriented towards the location of the short circuit, thereby separating the corresponding short-circuited lead section from the separating device 120a.

The short-circuit identification units 151a and 151b can be constructed in various ways that are familiar to a person skilled in the art. Since only the function and not the detailed structure of the short-circuit identification units 151a and 151b is significant for the separating device 120a described here, a more extensive description of the short-circuit identification units 151a and 151b can be omitted from this application.

The separating device 120a additionally comprises two voltage detectors 152a and 152b. According to the exemplary embodiment illustrated here, the voltage detectors 152a and 152b are realized by means of an operational amplifier whose output is coupled to the processor 160. As soon as the value of the voltage on the supply lead or on the first conductive track 126 falls below a predetermined voltage level or threshold value, the processor 160 activates the relevant switching element 131a and/or 131b such that the first conductive track 126 is interrupted.

It can also be seen from FIG. 1a that the separating device 120a additionally comprises a connection interface 161 for a live load 170, which is a loudspeaker 170 according to the exemplary embodiment illustrated here. It can be seen from FIG. 1a that one contact of the live load connection interface 161 is connected to the first conductive track 126, wherein the connection point lies exactly between the two switching elements 131a and 131b.

Since the connection of live loads can also result in the occurrence of faults, which can adversely affect a supply to adjacent electrical appliances and/or separating devices that are likewise connected to the supply lead, provision is further made for a first live load monitoring unit 162. According to the exemplary embodiment illustrated here, the first live load monitoring unit 162 is realized by means of an operational amplifier which detects the voltage at the live load. In the event of an unacceptable voltage drop, the processor which is connected behind the first live load monitoring unit 162 will close at least one of the two switching elements 131a and 131b, in order to decouple the obviously faulty live load 170 from the supply lead.

In order further to increase the functional reliability of the operation of the live load 170, provision is additionally made for a second live load monitoring unit 163. The second live load monitoring unit 163 is a short-circuit identification unit which is likewise connected to the processor 160 in a manner which is not illustrated. The processor can therefore open the switching elements 131a and/or 131b in the event of a short circuit in the region of the live load connection interface 161, and thus separate the live load connection interface 161 from the supply lead.

It is noted that a separating device having identical functionality can also be realized by arranging the two switching elements in the second conductive track 127. In this case, the separation of the supply lead is achieved by means of a separation of the ground lead. An electrical appliance 170 such as a loudspeaker 170, for example, can therefore advantageously be connected directly to the separating device 120a. Discrete connection interfaces in the supply lead are therefore not necessary for this purpose.

FIG. 1b shows a separating device 120b according to a second embodiment of the invention. The separating device 120b differs from the separating device 120a illustrated in FIG. 1a in that the voltage detectors 152a and 152b are replaced by overload current identification units 156a and 156b. According to the exemplary embodiment illustrated here, the overload current identification units 156a and 156b are likewise realized in each case by means of an operational amplifier, each of these being assigned a resistor 155a and 155b respectively. Of course, the overload current identification units 156a and 156b could also be combined with the voltage detectors 152a and 152b illustrated in FIG. 1a.

It can be seen from FIG. 1b that the resistors 155a and 155b are arranged in series with the two switching elements 131a and 131b in the first conductive track 126. In the case of a current flow via the supply lead or via the first conductive track 126, a voltage that is proportional to the current flow therefore drops at the resistors 155a or 155b, said voltage being registered by the overload current identification units 156a or 156b. If a maximum permitted current is exceeded, the processor which is connected behind the two overload current identification units 156a and 156b is induced to open at least one of the two switching elements 131a and 131b and hence to prevent the current flow via the supply lead.

It can also be seen from FIG. 1b that the separating device 120b differs from the separating device 120a illustrated in FIG. 1a in that no live load connection interface is provided. The other components of the separating device 120b are identical to the corresponding components of the separating device 120a, in terms of both their structure and their function, and therefore need not be explained again in detail here.

FIG. 1c shows a separating device 120c according to a third embodiment of the invention. The separating device 120c differs from the separating device 120a illustrated in FIG. 1a in that instead of two switching elements 131a and 131b, only one switching element 131 is provided. Monitoring of a live load 170 that is attached directly to the separating device 120c has also been omitted. The other components of the separating device 120c are identical to the corresponding components of the separating device 120a, in terms of both their structure and their function, and therefore need not be explained again in detail here.

As a result of using only one switching element 130, this being arranged in the first conductive track 126, the separating device 120c represents a minimized solution for monitoring and if necessary separating an energy-conducting connection lead. The checking of the electrical properties of the supply lead functions in exactly the same way as for the separating device 120a illustrated in FIG. 1a. After a fault has been identified, irrespective which side of the separating device 120c, the single switching element 130 is not closed again in this case. Since a live load attached to the supply lead can now be arranged either to the left or to the right of the separating device 120c in the drawing, the live load on the defective side of the separating device 120c will fail in any case. However, depending on the application concerned, such a failure can be fully covered by applicable regulations and hence permissible. Using the separating device 120c as a minimized solution for monitoring and if necessary separating an energy-conducting connection lead, applicable regulations can therefore be satisfied in an economical manner.

FIG. 2 shows an energy supply system 200 comprising a control center 205 and a closed loop-shaped energy-conducting electric lead 210. The control center comprises a first loop connection interface 206 and a second loop connection interface 207. A plurality of separating devices 220 are connected in series in the supply lead. Electrical sinks or live loads not shown in FIG. 2 are also attached to the supply lead. This can take place via live load connection interfaces in the separating devices 220 as described above with reference to FIG. 1a and/or via connection interfaces on the supply lead 220, said connection interfaces being located between the separating devices 220.

The energy supply to the individual live loads attached to the supply lead 210 takes place via the annular supply lead 210. The feeding of the supply lead during normal operation can take place in two different ways:

A) The feeding takes place via both the first loop connection interface 206 and the second loop connection interface 207:

In the event of a lead defect such as e.g. a short circuit in a lead section, the faulty lead section can be separated in this case, thereby interrupting the lead ring or lead loop. The interruption can be effected by activating the separating function in those separating devices immediately adjacent to the faulty lead section. The energy supply for the live loads which are attached to the fault-free lead sections is then provided, depending on their position in the supply lead, either via the first loop connection interface 206 or via the second loop connection interface 207.

B) The feeding takes place via the first loop connection interface only:

Only detection of the incoming voltage takes place at the second loop connection interface, and said incoming voltage can be used as an indicator of the present state of the supply lead 210. In the event of a lead defect such as e.g. a short circuit or an interruption, no voltage can actually be detected at the second loop connection interface 207. Consequently, if no voltage or a deviating voltage is measured at the second loop connection interface for a specific time, which is required as a maximum for the measurement and if necessary automatic repair of the loop-shaped lead 210, a defect in the supply lead can be inferred.

By virtue of the loop-shaped energy supply as described above, featuring a separation function that can be activated by means of separating devices 220, it is therefore possible to achieve a high level of supply reliability for the live loads that are attached to the supply lead 210. This is advantageous for voice alarm systems in particular, since a high electrical power in the form of alternating current with a low frequency is typically transferred via the supply lead, which simultaneously represents the cabling for the corresponding loudspeakers.

In comparison with known star-shaped cabling of the individual loudspeakers, wherein a cable extends between the control center and a loudspeaker in each case, the expense of the cabling is significantly reduced by the energy supply system described in this application, particularly when upgrades are required in a building.

It is noted that the described separating devices and the described energy supply system can be utilized not only for voice alarm systems but also in all other fields of hazard reporting technology.

It is further noted that the embodiments described here represent only a limited selection of possible design variants of the invention. It is thus possible to combine the features of individual embodiments with each other in a suitable manner, such that a person skilled in the art will consider a multiplicity of different embodiments to be clearly disclosed on the basis of the explicit design variants here.

1-17. (canceled)

18. A separating device for an energy-conducting electric lead, the separating device comprising:
a monitoring unit for checking electrical properties of a lead section of the lead adjacent to the separating device;
an energy storage device connected to said monitoring unit for assuring that a function of said monitoring unit can be maintained even in an event of a failure of the lead; and
a switching element coupled to said monitoring unit and configured to enable a separation of the adjacent lead section in the event of a failure of the lead.

19. The separating device according to claim 18, wherein the lead emerges from a control center and is fed back to the control center in the form of a loop.

20. The separating device according to claim 18, wherein said energy storage device comprises a capacitor.

21. The separating device according to claim 18, wherein said energy storage device comprises a double-layer capacitor.

22. The separating device according to claim 18, which further comprises a rectifier element connected between a node that is connectable to a terminal of the energy-conducting electric lead and said energy storage device.

23. The separating device according to claim 18, which further comprises a voltage transformer having an input and an output, wherein said input is connected to a terminal of the energy-conducting electric lead and said output carries an internal supply voltage of the separating device.

24. The separating device according to claim 18, wherein said monitoring unit comprises a processor.

25. The separating device according to claim 18, wherein said monitoring unit comprises at least one unit selected from the group consisting of a short-circuit identification unit; a voltage detector; and an overload current identification unit.

26. The separating device according to claim 18, which further comprises:
a further monitoring unit for checking the electrical properties of a further lead section of the lead, said further lead section being adjacent to the separating device; and
a further switching element connected to said further monitoring unit and configured to enable separation of the further adjacent lead section in the event of a failure of the lead.

27. The separating device according to claim 26, wherein said switching element and said further switching element are controllable such that, after both said switching elements have been opened as a result of an identified lead defect on the adjacent lead section, it is possible to close said further switching element that is assigned to the further adjacent lead section.

28. The separating device according to claim 18, which further comprises a live load connection interface for connecting a live load.

29. The separating device according to claim 28, which further comprises a live load monitoring unit connected to said live load connection interface and configured to check the electrical properties of a live load connected thereto.

30. An energy supply system for a plurality of electrical appliances, the energy supply system comprising:
a control center;
an electric lead issuing from said control center and fed back to said control center in form of a loop; and
at least one separating device according to claim 18 connected to said electric lead for supplying electrical energy from said control center to said separating device via said electric lead.

31. The energy supply system according to claim 30, wherein the electrical appliances are peripheral units of a hazard reporting system.

32. The energy supply system according to claim 30, wherein said control center comprises:
a first loop connection interface connected to a lead section of said electric lead emerging from said control center; and
a second loop connection interface connected to a lead section of said electric lead returning to said control center.

33. The energy supply system according to claim 32, wherein said control center is configured to enable said electric lead to be fed via said first loop connection interface and said second loop connection interface.

34. The energy supply system according to claim 32, wherein said control center is configured to enable said electric lead to be fed via said first loop connection interface and a voltage to be detected at said second loop connection interface.

35. The energy supply system according to claim 34, wherein said control center is additionally configured to enable the electric lead to be fed via both said first loop connection interface and via said second loop connection interface, if no voltage is detected at said second loop connection interface for a predetermined time.

36. The energy supply system according to claim 30, wherein said control center is configured to selectively interrupt a feeding of the electric lead for a predetermined time.

37. A method for providing electrical energy from a control center to a plurality of electrical appliances via an energy-conducting electric lead, the method which comprises:
providing at least one separating device according to claim 18;
checking the electrical properties of a lead section of the lead, the lead section being adjacent to the separating device; and
separating the lead section that is adjacent the separating device if a failure of the lead is detected.
